(19) United States
(12) Patent Application Publication
(10) Pub. No.: US 2009/0033958 A1
(43) Pub. Date: Feb. 5, 2009

(54) Image Processing Apparatus for Displaying a Control Method Corresponding to a Control Code Provided in a Document

(76) Inventor: Osamu Torii, Tokyo (JP)

Correspondence Address: IPUSA, P.L.L.C, 1054 31ST STREET, N.W., Suite 400, Washington, DC, 20007, US

(21) Appl. No.: 12/176,507

(22) Filed: Jul. 21, 2008

(30) Foreign Application Priority Data
Jul. 31, 2007 (JP) 2007-199911

(51) Int. Cl. G06F 15/00

(52) U.S. Cl. 358/1.9

(57) ABSTRACT

An image processing apparatus detects a control code provided to a document in order to prevent image data, which is created by reading the document, from being leaked in accordance with the detected control code. A control table storage part stores the control code by relating to a control method to prevent leaking. A control method display section displays the control method, which is retrieved from the control table storage part, on a display part based on the control code.

### BACKGROUND OF THE INVENTION

1. Field of the Invention

The present invention relates to image processing apparatuses and, more particularly, to an image processing apparatus that displays a control method corresponding to a control code.

2. Description of the Related Art

Information recorded on a document may be illegally copied or scanned, and may leak outside. In order to prevent such a leak of information, there are suggested various techniques to prevent information from being leaked. One of the techniques is to embed a control code into an image on a document. If a copy machine reads such a control code, the copy machine performs a leak preventing control corresponding to the read control code, such as, for example, preventing a copying operation or encrypting information on a document.

Japanese Laid-Open Patent Application No. 2006-333015 suggests an image forming apparatus that notifies a user of a fact that a document provided with a control code is copied, because a leak prevention can be made easy by a person having authority, who embedded the control code, recognizing the fact that an attempt to copy the document was made. The image forming apparatus disclosed in this patent document detects a tint block in an image read from a document and compares the detected tint block with a predetermined tint block pattern, and notifies a person corresponding to the detected tint block pattern of the fact that the document was copied.

If a third person who is not given authority tries but fails to copy a document, there is no need to let the third person know the reason why he or she cannot copy the document. On the other hand, a user who is authorized to handle a confidential document needs to know a control method performed based on a control code provided in the confidential document. That is, it is inconvenient for such a user to have no way of knowing the control method corresponding to the control code provided in the confidential document which the user handles. Because there are many kinds of control codes, there is a problem in that a user cannot know which control code is embedded in a document in such a case of the above-mentioned patent document that the user is merely notified of a fact that an attempt was made to copy a document in which a control code is embedded.

### SUMMARY OF THE INVENTION

It is a general object of the present invention to provide a novel and useful image processing apparatus in which the above-mentioned problem is eliminated.

A more specific object of the present invention is to provide an image processing apparatus and method and an image forming apparatus that can notify a user of a control method corresponding to a control code embedded in a document.

In order to achieve the above-mentioned objects, there is provided according to one aspect of the present invention an image processing apparatus that detects a control code provided to a document in order to prevent image data, which is created by reading the document, from being leaked in accordance with the detected control code, the image processing apparatus comprising: a control table storage part that stores the control code by relating to a control method to prevent leaking; and a control method display section that displays the control method, which is retrieved from the control table storage part, on a display part based on the control code.

Additionally, there is provided according to another aspect of the present invention an image processing method performed by an image processing apparatus that detects a control code provided to a document in order to prevent image data, which is created by reading the document, from being leaked in accordance with the detected control code, the image processing method comprising: storing the control code by relating to a control method to prevent leaking; and displaying the control method, which is retrieved from the control table storage part, on a display part based on the control code.

Further, there is provided in another aspect of the present invention a computer readable program for causing an image processing apparatus to perform functions of: detecting a control code provided to a document in order to prevent image data, which is created by reading the document, from being leaked in accordance with the detected control code; storing the control code by relating to a control method to prevent leaking; and displaying the control method, which is retrieved from the control table storage part, on a display part based on the control code.

Other objects, features and advantages of the present invention will become more apparent from the following detailed description when read in conjunction with the accompanying drawings.

### BRIEF DESCRIPTION OF THE DRAWINGS

FIG. 1 is a block diagram showing a system structure of an image processing apparatus;

FIG. 2A shows a reserved pixel area where a control code is recorded;

FIG. 2B shows an example of a control code recorded in the reserved pixel area;

FIG. 3 shows contents of a control table in which a control method is related to a control code ID;

FIG. 4 shows an example of the control table of a print system when a specific control method is registered as a control code ID indicating nonpermission;

FIG. 5 shows an example of a display screen for a control method displayed on an operation/display part;

FIG. 6 is a flowchart showing a procedure of a system control part displaying a control method;

FIG. 7 is a block diagram of a system control part according to a second embodiment of the present invention;

FIG. 8 shows an example of the control method and a reduced image displayed on an operation/display part;

FIG. 9 is a flowchart of a procedure of the system control part to display the control method together with the reduced image;

FIG. 10 shows an example of the control methods listed and displayed simultaneously on the operation/display part;

FIG. 11 is a flowchart of a procedure of the system control part to list and display the control methods;

FIG. 12 shows an example of reduced images and control methods listed and simultaneously displayed on the operation/display part;

FIG. 13 is a flowchart of a procedure of the system control part to list and simultaneously display a plurality of control methods and a plurality of reduced images;

FIG. 14 is a block diagram of a system control part according to a third embodiment of the present invention;

FIG. 15 shows an example of a display screen of a plurality of control methods, which allows selection of an outputting means;

FIG. 16 is a flowchart of a procedure of the system control part to display control methods and acquire a desired outputting means selected by a user;

FIG. 17 is a flowchart of a procedure of the system control part to display a control method and acquire an outputting means selected for each page.

FIG. 18 shows an example of a display screen of control methods displayed on the operation/display part for each address;

FIG. 19 is a flowchart of a procedure of the system control part to display a control method and acquire information regarding whether to transmit or not, which is selected by a user for each address;

FIG. 20 is a block diagram of the system control part according to a fourth embodiment of the present invention;

FIG. 21 shows an example of an output record log; and

FIG. 22 is a flowchart of a procedure of the system control part to display a control method and indicate a procedure of recording a result of an output.

### DETAILED DESCRIPTION OF THE PREFERRED EMBODIMENTS

A description will now be given, with reference to the drawings, of embodiments of the present invention.

### First Embodiment

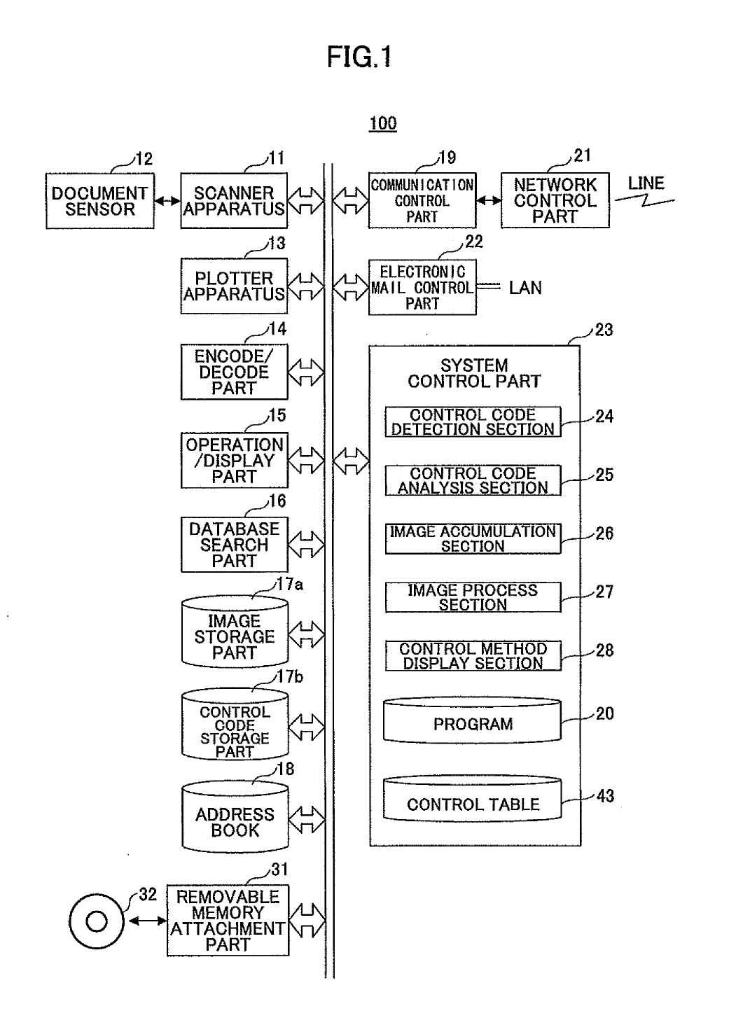

FIG. 1 is a block diagram showing a system structure of an image processing apparatus 100. The image processing apparatus 100 may be a copy machine, a scanner apparatus, a facsimile machine or a multi-function printer (MFP) having aforementioned functions.

Various control codes are embedded by printing or the like in images of documents which the image processing apparatus 100 reads. The image processing apparatus 100 has a function of performing an information leak preventing control corresponding to a control code, such as marking out an image by black or prohibiting printing of an image for mail transmission. Accordingly, a leak of information contained in a document being copied and transmitted via electronic mail can be prevented. The image processing apparatus 100 is capable of displaying contents of various control codes embedded in each page of a document. Thus, a user can easily check the control codes embedded in the document, which improves a convenience of use of the image processing apparatus 100.

<Structure of the Image Processing Apparatus 100>

The image processing apparatus 100 comprises: a scanner apparatus 11 for reading a document; a document sensor 12 that detects a setting of the document; a plotter apparatus 13 that forms an image and printing the image on a recording paper; an operation/display part 15 that displays contents of a control code and inputs an operation of a user through a touch panel or a keyboard; a database search part 16 for searching a database; an image storage part 17a that stores image data acquired by reading a document or received through a communication line; a control code storage part 17b that stores a detected control code; and an address book 18 that stores registered electronic mail addresses, facsimile numbers, IP addresses, etc. It should be noted that the operation/display part 15 may be separated into a display part that displays contents of a control code and an operation part that inputs an operation of a user through a touch panel or a keyboard.

The image processing apparatus further comprises: a communication control part 19 that controls a network control part 21 to be connected to a terminal designated by a facsimile number or the like; the network control part 21 that is connected to a communication line to transmit or receive a call; an electronic mail control part 22 that is connected to a local area network (LAN) and designates a protocol process and an address for transmitting and receiving electronic mail; a removable memory attachment part 31 that reads information from or writes information on a recording medium 32 attached thereto; and a system control part 23 that controls the entire image processing apparatus 100.

The scanner apparatus 11 is an apparatus for optically reading an image. For example, in the scanner apparatus 11, a light is irradiated from a light source onto a document placed on a contact glass provided in the image processing apparatus 100, and focuses the light reflected by the document onto a photoelectric conversion device such as a charge coupled device (CCD) through an optical system. An electric signal converted by the photoelectric conversion device is subjected to a noise reducing process by a correlative double sampling circuit and a gain adjustment process by an automatic gain control circuit, and, thereafter, converted into a digital signal (hereinafter, referred to as image data) by an analog/digital conversion circuit.

An image accumulation section 26 of the system controller 23 stores image data of a documents which is read by the scanner apparatus 11, in the image storage part 17a. If the document contains a plurality of pages, the image accumulation section 26 stores sets of image data by adding a serial number in an order of reading.

The plotter apparatus 13 is an apparatus for forming an image of the image data on a recording paper according to an electrophotographic method. For example, the plotter 13 irradiates a laser light, which is optically modulated in response to the image data, onto a surface of a photosensitive material. Because a toner moves to an exposed portion due to an electrostatic force, a toner image is formed on the surface of the photosensitive material. Then, the toner image is transferred onto a recording paper. The transferred toner image is fixed on the recording paper by actions of heat and pressure. The image data to form the toner image is data of an image of a document read by the scanner apparatus 11 or facsimile image data received by the communication control part 19 and decoded by the encode-decode part 14.

The system control part 23 is constituted as a computer in which a CPU, a ROM, a RAM, an HDD, an NV-RAM, a data input/output interface, etc., are interconnected by an internal bus. A control code detection section 24, a control code analysis section 25, the image accumulation section 26, an image process section 27, and a control method display section 28 are performed by the CPU of the system control part 23 executing a program 20 stored in the HDD, ROM, or the NV-RAM (hereinafter, simply referred to as a memory).

The control code detection section 24 detects a control code from the image data, and, then, the control code analysis section 25 analyzes the control method which the detected control code indicates. The image accumulation section 26 stores in the image storage part 17a image data acquired by reading a document by the scanner apparatus 11, image data received by the communication control part 19, and image data received by the electronic mail control part 22. The image process section 27 processes the image data stored in the image storage section 17a. The control method display section 28 retrieves a control method from a control table 43 stored in the memory (a control table storage part) in accordance with the control code, and displays the retrieved control method on the operation/display part 15.

It should be noted that the program 20 may be installed from the removable memory attachment part 31 to the system control part 23 in a state where the program 20 is stored in the recording medium such as a memory card or an optical disc, or downloaded from a predetermined server through the LAN and installed to the system control part 23.

<Detection of a Control Code>

A description will be given below of a control code and a control performed by the image processing apparatus 100. Because the control code may be embedded in each page, the control code detection section 24 detects a presence of a control code on an individual page basis. If a control code is embedded and detected, the control code analysis section 25 analyzes a kind of the control code and stores the control code in the control code storage part 17b by corresponding to a page number.

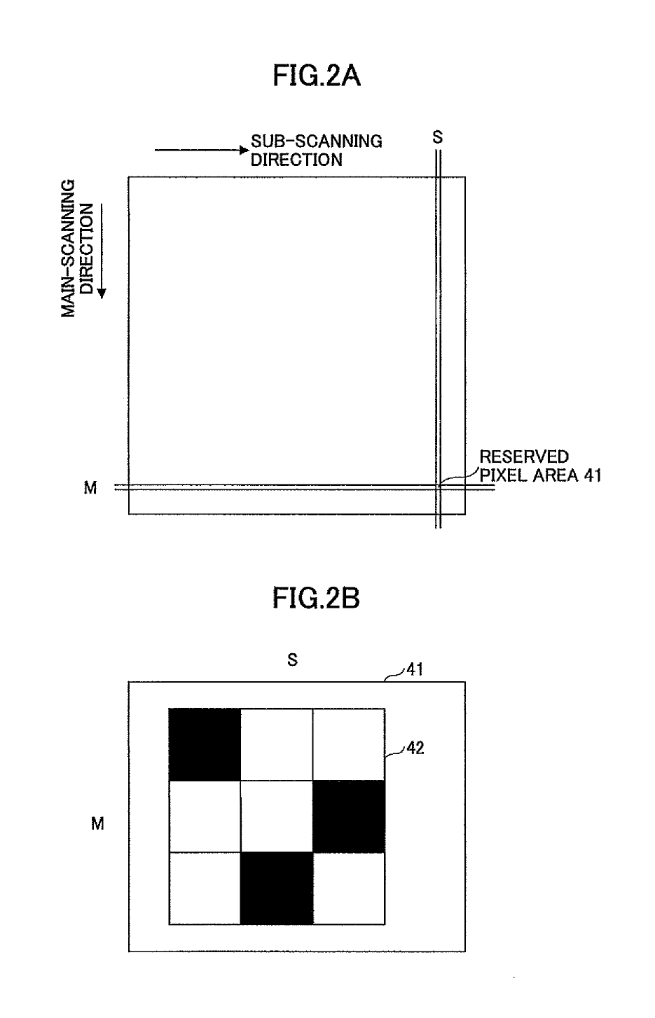

FIG. 2A shows a reserved pixel area 41 where a control code is recorded. The reserved pixel area 41 is provided to a document at a predetermined position determined by a main-scanning direction and a sub-scanning direction. The reserved pixel area 41 is an area where a control code is recorded by being separated from an image formed by the image data. The reserved pixel area 41 has a size which can contain a plurality of pixels in each of the main-scanning direction and the sub-scanning direction so that a control code is recorded in the reserved pixel area 41. It is preferable that the reserved pixel area 41 is provided in an area, such as an area on a bottom-right corner outside the image on the document; which area is hardly recognized by a user. Alternatively, the size of the image may be slightly reduced and the reserved pixel area 41 may be provided in an area which does not overlap the image.

FIG. 2B shows an example of a control code 42 recorded in the reserved pixel area 41. The reserved pixel area 41 may be divided into a plurality of blocks so that a kind of the control code 42 is indicated by binary information such that, for example, each of the blocks is marked out or not marked out. For example, the control code 42 may be represented by an arrangement pattern of the marked out blocks. Alternatively, a kind of the control code 42 may be indicated by combining binary information represented by blocks having directivity, such as a two-dimensional bar code. The control table storing a relationship between the kind of the control code 42 and a control method corresponding thereto is stored in the memory. It should be noted that the control code 42 may not be printed on the document but may be stored in an IC chip that is applied to or embedded in a document.

<Outline of the Information Leak Preventing Control>

A description will be given below of an outline of the information leak preventing control. The image data binarized by the scanner 11 is sent to the system control part 23. The control code detection section of the system control part 23 specifies the predetermined reserved pixel area 41 and detects the control code 42. The control code analysis section 25 changes the control code 42 into a numerical value of, for example, 0 to 28 (hereinafter, referred to as a control code ID) based on the arrangement pattern of the detected control code 42. Then, the image process section 27 detects a control method corresponding to the detected control code 42 based on the control code ID by referring to the control table 43, and performs a control to prevent a leak of information, such as marking out the image, encrypting mail data, or prohibiting a copying operation.

<Control Method>

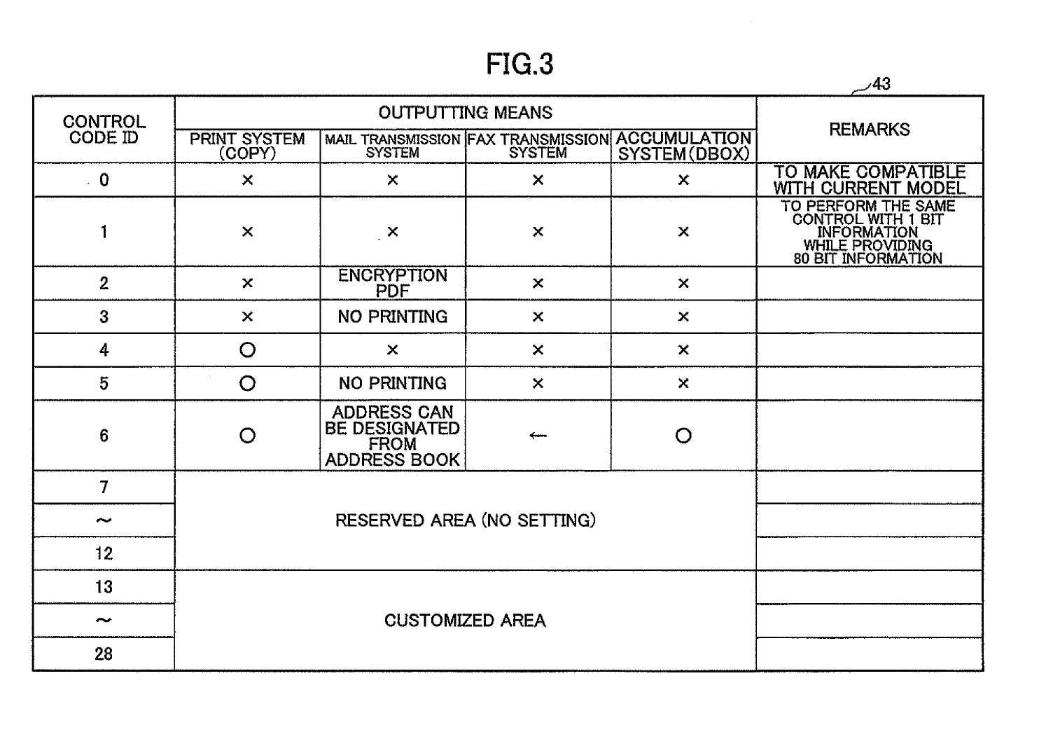

FIG. 3 shows contents of the control table in which a control method is related to a control code ID. In FIG. 3, control methods are registered for each outputting means by being corresponded to the control code ID embedded in the image. In the control table 43 of FIG. 3, a print system, a mail transmission system, a FAX system and an accumulation system (DBOX: Document Box) are set as the outputting means. In the control table 43, “◯” indicates permission of outputting and “X” indicates nonpermission of outputting. In addition to the indication of permission and nonpermission, a specific control method may be registered such as in a mail transmission system.

For example, although an output is permitted in the print system when the control code ID is “4”, an output is not permitted in the mail transmission system (it cannot transmit by mail). It should be noted that a user can set up a specific control method corresponding to the indication of “X” (output is not permitted). For example, when transmitting by mail a document into which the control code ID “6” is embedded, transmission is permitted if the destination is an address registered in the address book 18.

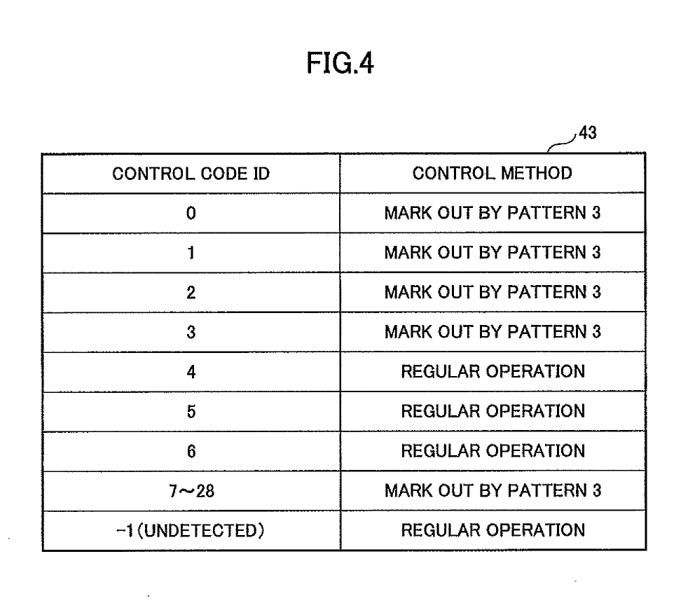

FIG. 4 shows an example of the control table 43 of a print system when a specific control method is registered as the control code ID indicating nonpermission. It should be noted that the setting of the image processing apparatus 100 shall be as follows.
detection setup: control code reading ON
process for output nonpermission eject paper by marking out an entire paper/do not transmit/do not accumulate
mark out pattern: pattern 3

As shown in the control table 43 of FIG. 3, if the control code ID is 0 to 3, outputting is not permitted. Thus, in FIG. 4, if the control code ID is 0 to 3, a control method of “mark out by pattern 3” can be registered.

Additionally, although a reserved area is assigned to the control code ID of 7 to 28 in FIG. 3, a control method of “mark out by pattern 3” is registered in FIG. 4 on the assumption that nonpermission of outputting is also set up in FIG. 4. It should be noted that if a control code is not detected, “−1” indicating undetected is assigned to the control code ID.

It should be noted that the mark out pattern is previously registered in the plotter apparatus 13 so that the plotter apparatus 13 marks out a recording paper (image data) in accordance with the pattern number by sending the pattern number (here, pattern 3) to the plotter apparatus 13. For example, the plotter 13 changes the gradation and phase of the image data to a fixed gradation and phase corresponding to the pattern number in order to apply an image process so that the original image of the document becomes unreadable. The mark out pattern may be changed to an erasure of image, an exchange of a part of image for each minute area, or a replacement of the image with a scenic image that is not relevant to the original image.

<Example of Displaying the Control Method>

The image processing apparatus 100 according to the present embodiment displays a control method on the operation/display part 15. The control method display section 28 of the system control part 23 retrieves a control method to which the control code ID is related, by referring to the control table 43 based on the control code ID analyzed by the control code analysis section 25, and displays the control method on the operation/display part 15.

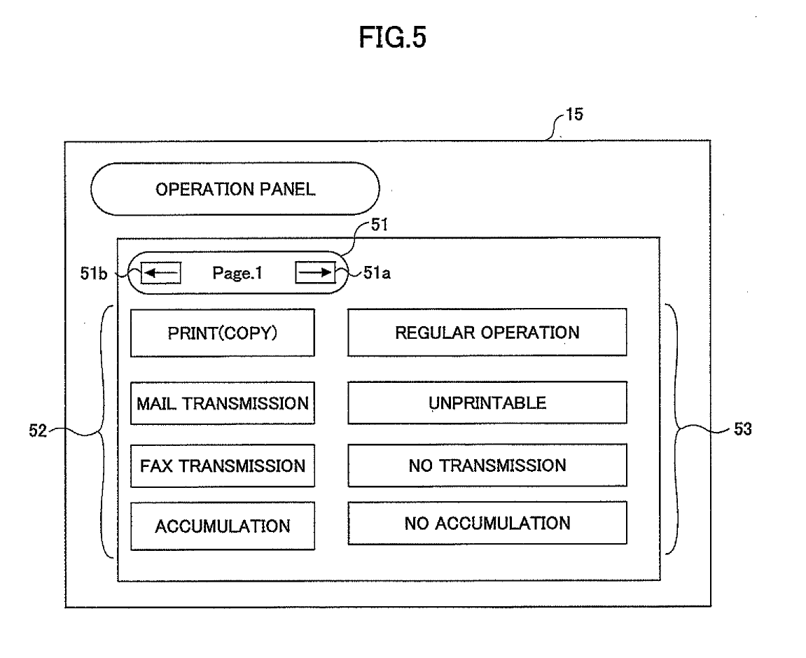

FIG. 5 shows an example of a display screen for the control method displayed on the operation/display part 15. The display screen has three display columns, a page number column 51 of a document, an outputting means column 52, and a control method column 53. The page number column 51 is a column that displays consecutive numbers added by the scanner apparatus 11 in an order of reading the document. The display screen of FIG. 5 shows a case where the control code ID is “5”. Thus, “print (copy)” is indicated as “regular operation”, “mail transmission” is indicated as “unprintable”, “FAX transmission” is indicated as “no transmission” and “accumulation” is indicated as “no accumulation”. A page skip button 51a and a page return button 51b are formed in the page number column 51 so that a user can check the control method corresponding to the control code embedded in or provided to a desired page.

<Control Procedure by the System Control Part 23>

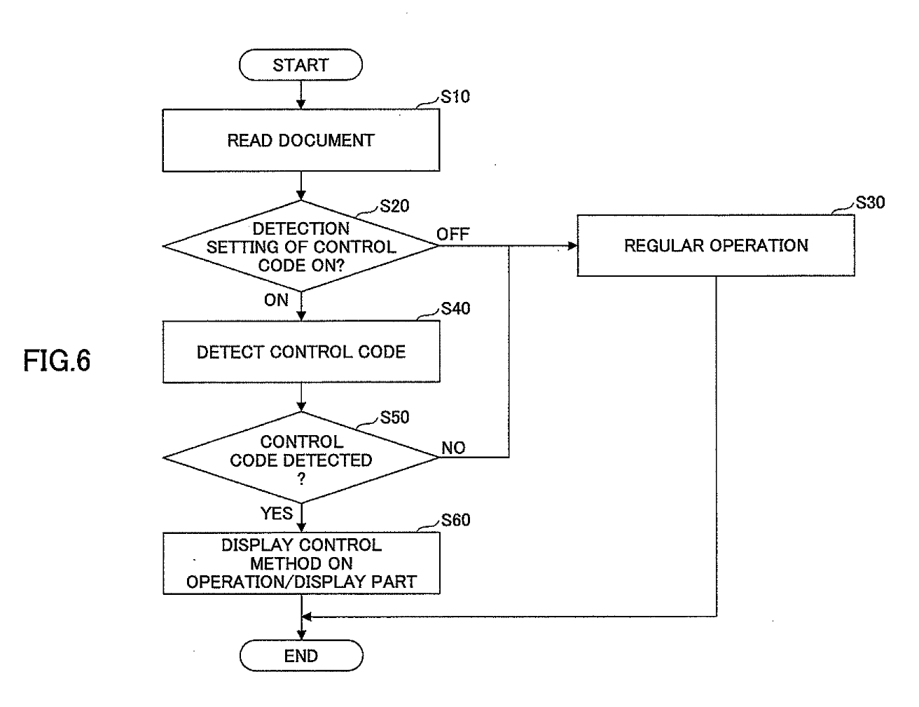

FIG. 6 is a flowchart showing a procedure of the system control part 23 displaying a control method. When a user sets a document in the image processing apparatus 100 in a state where the image processing apparatus 100 is activated and inputs an instruction to perform reading (read execution command) through the operation/display part 15, the system control part 23 receives the read execution command and causes the scanner apparatus 11 to read the document (step S10). Then, the system control part 23 determines whether the detection setting for reading the control code is “ON” or “OFF” (step S20). The detection setting is set previously by a user or set to a default value.

If the detection setting is “OFF” (No of step S20), the image processing apparatus 100 performs a regular operation according to the contents of the user operation without performing a detection of a control code (step S30). If, for example, the user designates a copy, a copy of the document is made, and if the user designates a FAX transmission, the document is sent by facsimile. It should be noted that the control code may be detected automatically by, for example, a copying operation.

On the other hand, if the detection setting is “ON” (Yes of step S20), the control code detection section 24 detects the control code (step S40). Because the scanner apparatus 11 sequentially reads the document and sends the read image data to the system control part 23, if the control code 42 is embedded in the document, the control code detection section 24 detects the embedded control code 42.

The system control part 23 determines whether the control code 42 is embedded (step S50). If the control code 42 is not embedded (No of step S50), the image processing apparatus 100 performs a regular operation according to the contents of the user operation, for example, a copying operation of the document (step S30). On the other hand, if the control code 42 is embedded (Yes of step S50), the control method display section 28 displays the control method on the operation/display part 15 (step S60). That is, the control code analysis section 25 changes the control code 42 into the control code ID based on the arrangement pattern of the control code 42. Then, the control method display section 28 retrieves the control method corresponding to the control code ID by referring to the control table 43, and displays the control method on the operation/display part 15.

According to the above-mentioned process, the display screen of the control method as shown in FIG. 5 is displayed on the operation/display part 15. Thus, the user can recognize easily which outputting means and which outputting method are permitted by checking the control method corresponding to the embedded control code. Because the document has been read and the image data has been stored in the image storage part 17a, the image data can be output by merely selecting the outputting means.

### Second Embodiment

In the second embodiment, a description will be given of the image processing apparatus 100 displaying image data in addition to a control method.

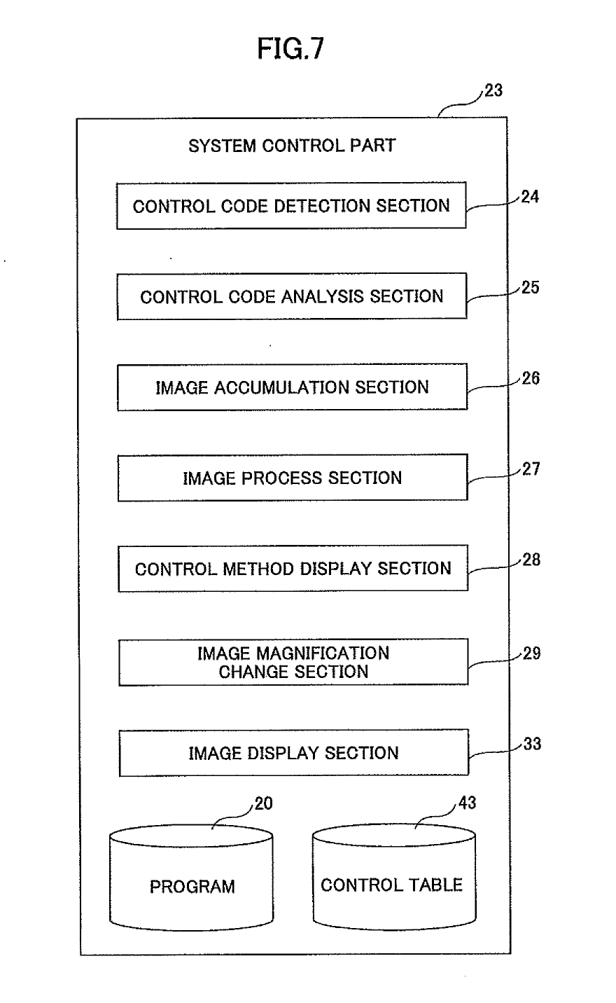

FIG. 7 is a block diagram of the system control part 23 according to the second embodiment. In FIG. 7, parts that are the same as the parts shown in FIG. 1 are given the same reference numerals, and descriptions thereof will be omitted. The system control part 23 of FIG. 7 includes an image magnification change section 29 for changing a magnification of the read image to a different size and an image display section 33 for displaying the magnified image on the operation/display part 15.

The image magnification change section 29 reduces the size of the image of the document into a predetermined smaller size by removing pixels of the image data corresponding to the longitudinal direction and transverse direction of the document for each number of pixels determined by a magnification ratio. The reduced image is stored in the image storage part 17a by being corresponded to the page number of the document. Then, the image display section 33 displays the reduced image on the operation/display part 15.

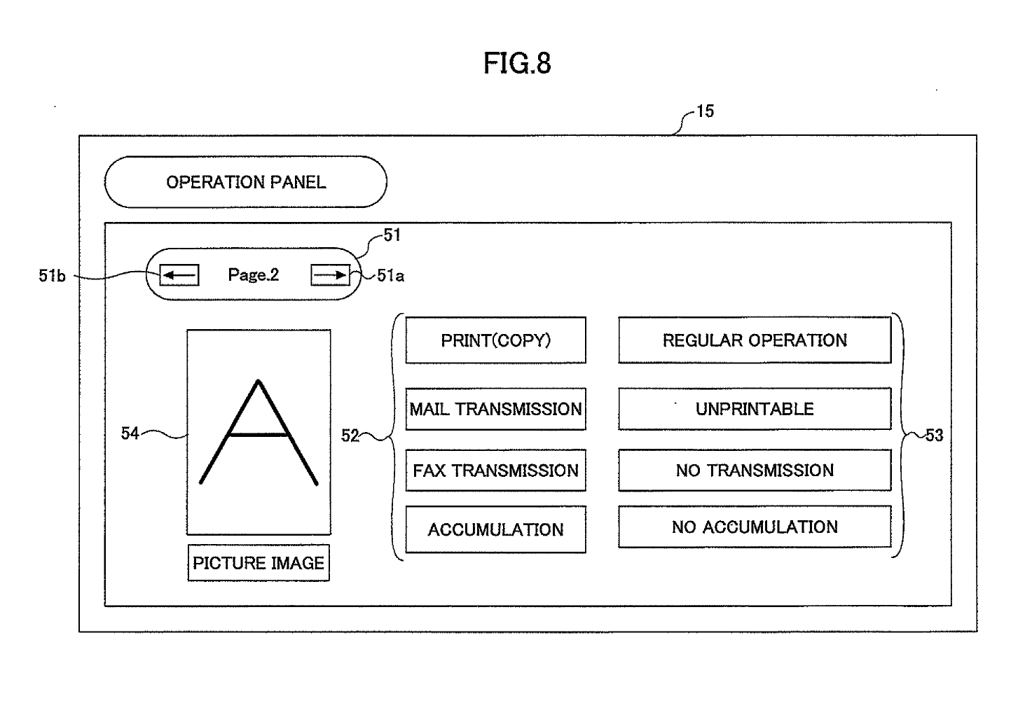

FIG. 8 shows an example of the control method and the reduced image displayed on the operation/display part 15. In FIG. 8, parts that are the same as the parts shown in FIG. 5 are given the same reference numerals, and descriptions thereof will be omitted. In the present embodiment, a reduced image column 54 of the page concerned is provided in addition to the columns indicating the control method. Accordingly, a user can check the control method corresponding to the control code while checking the image of the document page by page.

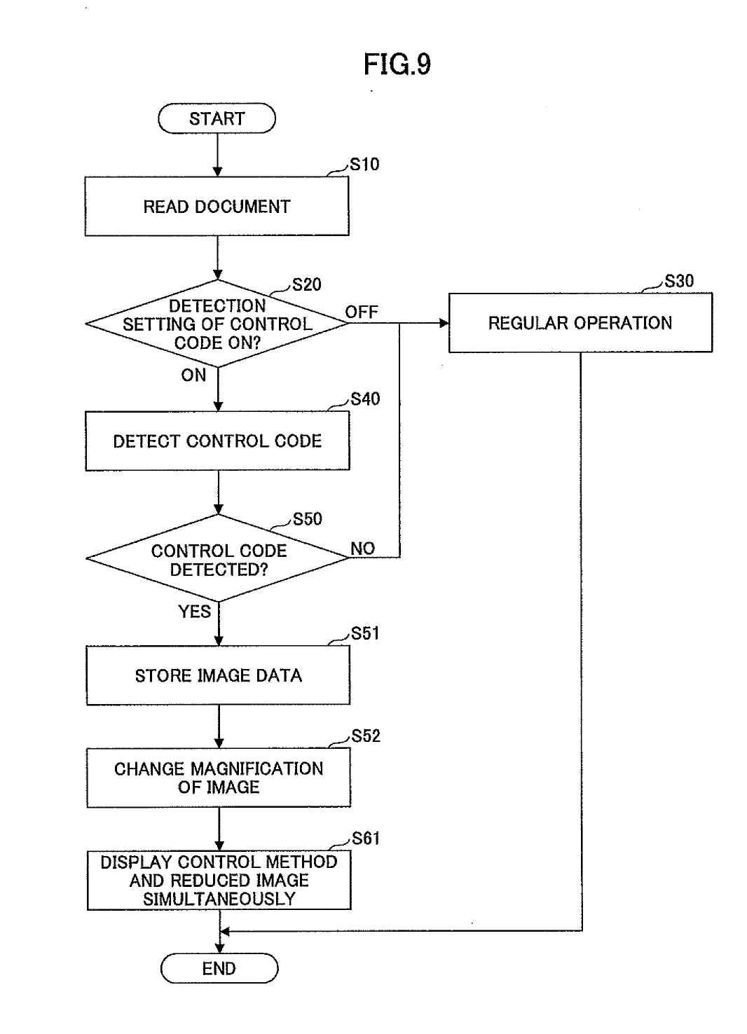

FIG. 9 is a flowchart of a procedure of the system control part 23 to display the control method together with the reduced image. In FIG. 9, steps that are the same as the steps shown in FIG. 6 are given the same step numbers, and descriptions thereof will be omitted. In the present embodiment, in order to display the image page by page, steps S51 and S52 are included to change the magnification of the image when the control code 42 is embedded.

If the control code 42 is embedded (Yes of step S50), the image accumulation section 26 relates the image data to the page number and stores the image data in the image storage section 17a (step S51). After the image data is stored in the image storage part 17a, the image magnification change section 29 applies a magnification change process to the image data to reduce the image and stores the reduced image in the image storage part 17a (step S52). Then, the control method display section 28 displays the control method on the operation/display part 15, and the image display section 33 displays the reduced image in the reduced image column 54 of the operation/display part 15 (step S61).

According to the above-mentioned process, the display screen of the control method such as shown in FIG. 8 is displayed on the operation/display part 15. Thus, according to the present embodiment, comparison and checking of the contents of the document and the control method are facilitated by displaying the reduced image of each page simultaneously with the display of the control method, thereby improving a convenience of use of the image processing apparatus 100.

<List Display of the Control Method and the Reduced Image>

List Display of the Control Method

Although a list display of the control method and the reduced image can be made in FIG. 8, it is convenient for a user to view the control method for each predetermined number of pages because the user is not required to turn over pages. Because the upper limit of a number of pages of a document is not fixed while the display range of the operation/display part 15 is limited, the control methods corresponding to, for example, each five to ten pages are listed and displayed. In the present embodiment, the control method display section 28 displays the control methods according to a predetermined format to display the control methods corresponding to, for example, ten pages. It should be noted that all pages of the document may be listed and displayed instead of displaying for each predetermined number of pages such as each ten pages.

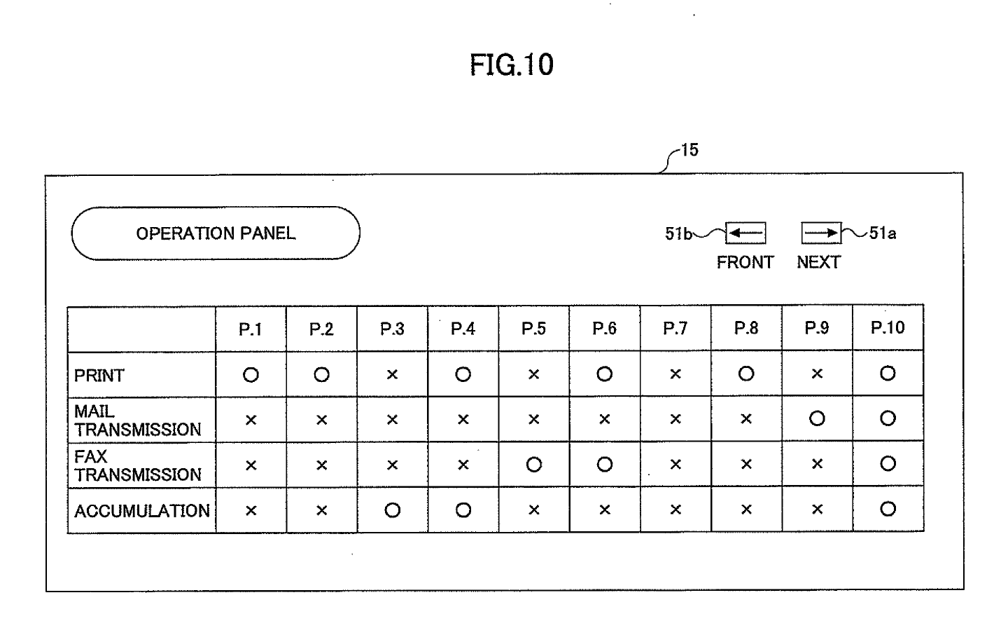

FIG. 10 shows an example of the control method listed and displayed on the operation/display part 15. In the display screen of FIG. 10, the control methods for ten pages are displayed in a table form in which each control method is related to permission “◯” and nonpermission “X” for each of the four outputting means. According to such a display screen, a user can instantly recognize the control method corresponding to the control code 42 embedded in each page. It should be noted that if the document contains eleven pages or more, the control methods corresponding to pages 11 to 20 can be listed and displayed by operating the page skip button 51a.

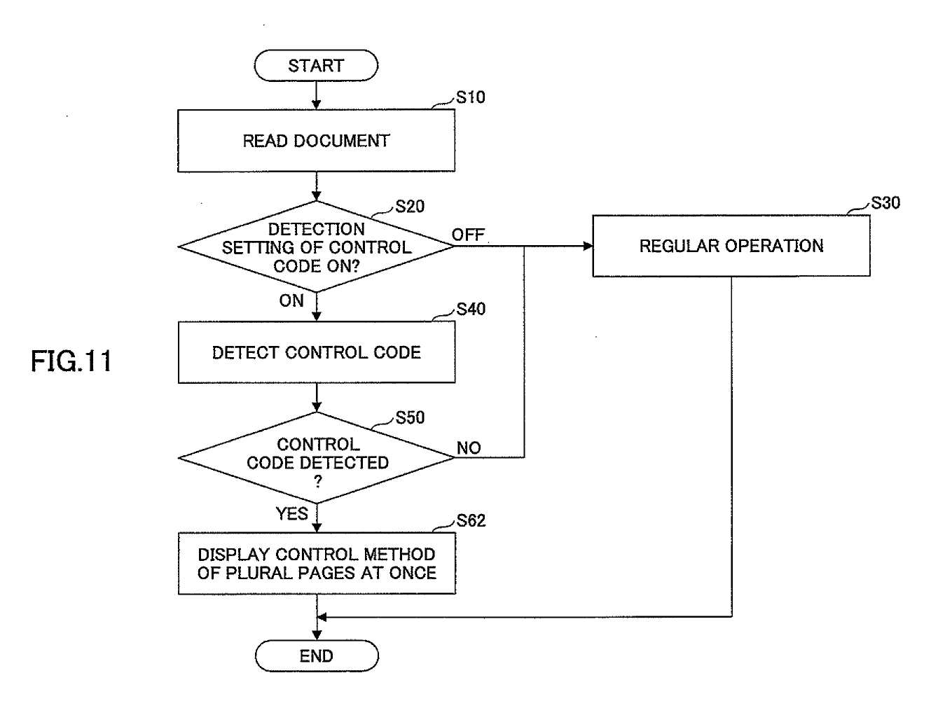

FIG. 11 is a flowchart of a procedure of the system control part 23 to list and display the control methods. In FIG. 11, steps that are the same as the steps shown in FIG. 9 are given the same step numbers, and descriptions thereof will be omitted. The procedure of FIG. 11 differs from the procedure of FIG. 9 in that the procedure of FIG. 11 includes a step S62 for listing and displaying the control method corresponding to ten pages.

Namely, if the control code 42 is embedded (Yes of step S50), the control method display section 28 lists the control methods for a predetermined number of pages and displays the list of the control methods on the operation/display part 15 (step S62). According to the above-mentioned process, the list of the control methods such as shown in FIG. 10 is displayed on the operation/display part 15. Therefore, a user can check the control method of each page without operating the page skip button 51a and the page return button 51b, thereby improving a convenience of use.

List Display of Control Methods and Reduced Images

A description will be given below of a list display of a plurality of control methods and a plurality of reduced images. By displaying not only a plurality of control methods but also a plurality of reduced images, a user can check the control methods corresponding to a plurality of pages by referring to the images of the document without performing a page skipping or forwarding operation, thereby improving a convenience of use. That is, because the control methods of a plurality of pages and the reduced images of the plurality of pages concerned are simultaneously displayed on one display screen, a user can easily and instantly check the control methods of the plurality of pages by referring to the reduced images of the pages.

In order to achieve the above display, the image magnification change section 29 reduces an image of each page by a predetermined magnification ratio so that images corresponding to, for example, five pages can be displayed on the operation/display part 15. Then, the control method display section 28 displays the control methods according to a predetermined format to display control methods corresponding to, for example, five pages. Additionally, the image display section 33 lists and displays simultaneously the reduced images corresponding to five pages on the operation/display part 15 (thumbnail display).

It should be noted that the number of pages listed simultaneously is not limited to five, and control methods and the reduced images corresponding to all pages of a document may be listed and displayed simultaneously. In such a case, the image magnification change section reduces images in accordance with the number of pages to be listed and displayed.

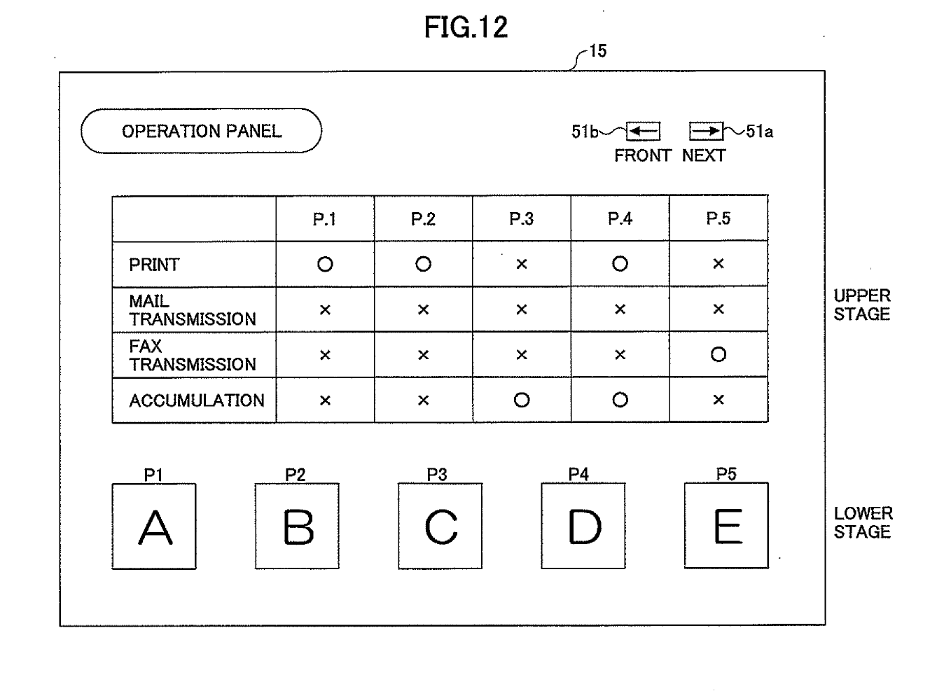

FIG. 12 shows an example of reduced images and control methods listed and displayed on the operation/display part 15. A plurality of control methods are listed and displayed on an upper part of the operation/display part 15 in the same manner as that shown in FIG. 10, and a plurality of reduced images are listed and displayed simultaneously on a lower part of the operation/display part 15. Because the reduced images of a plurality of pages are displayed together with the control methods of the plurality of pages, a user can check the contents and control methods of the plurality of pages simultaneously without operating the page skip button 51a and the page return button 51b.

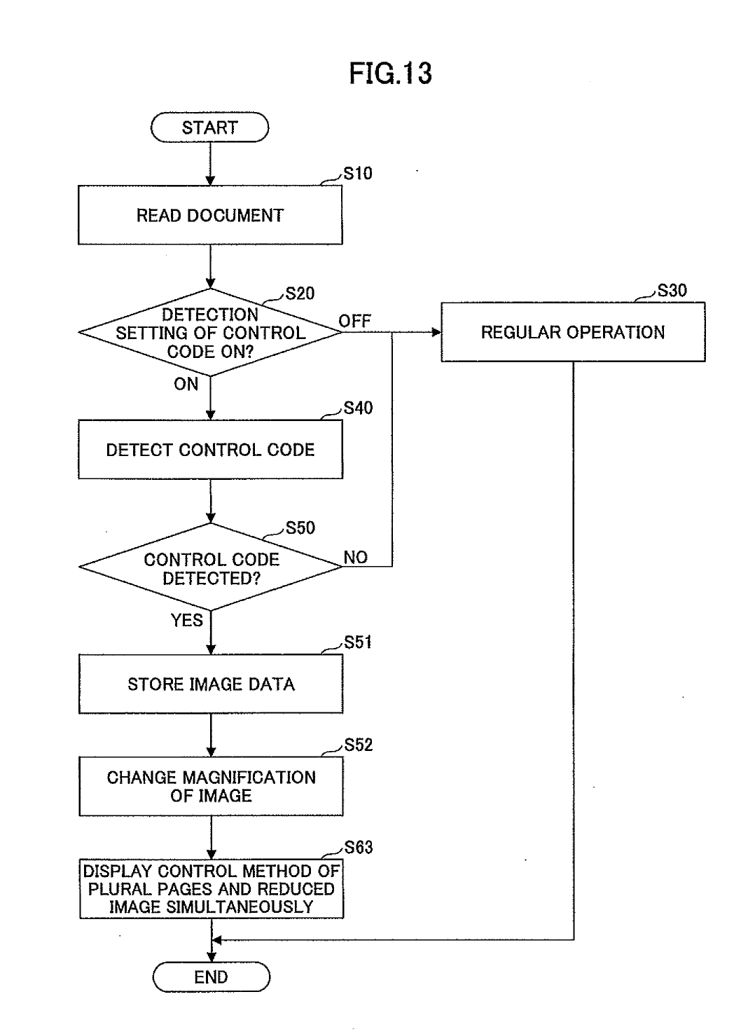

FIG. 13 is a flowchart of a procedure of the system control part 23 to list and display the control methods and the reduced images. In FIG. 13, steps that are the same as the steps shown in FIG. 11 are given the same reference numerals, and descriptions thereof will be omitted. The procedure of FIG. 13 differs from the procedure of FIG. 11 in that the procedure of FIG. 13 includes a step S63 to list and display the control methods and the reduced images corresponding to five pages. That is, if the control code 42 is embedded (Yes of step S50), the image magnification change section 29 applies a magnification change process to the image data stored in the image storage part 17a, and the control method display section 28 lists and displays the control methods on the operation/display part 15 and the image display section 33 lists and displays the reduced images on the operation/display part 15 on which the control methods are displayed (step S63). According to the above-mentioned process, the control methods and the reduced images shown in FIG. 12 are listed and displayed simultaneously on the operation/display part 15. It should be noted that although the control method and the reduced images are listed and simultaneously displayed in the present embodiment, each of the list of control methods and the list of reduced images may be displayed alternately by switching by an operation of a predetermined switch button.

### Third Embodiment

Although the control method corresponding to the control code 42 embedded in each page is displayed to a user in the above-mentioned first and second embodiments, it is convenient for the user if the user can select outputting means in accordance with the displayed method. In the present embodiment, a description is given of the image processing apparatus 100 that allows a user to select outputting means. Accordingly, if, for example, it is not permitted in a print system but permitted in a mail transmission system, a user can output through a different outputting means (mail transmission system), which improves an operability of the apparatus.

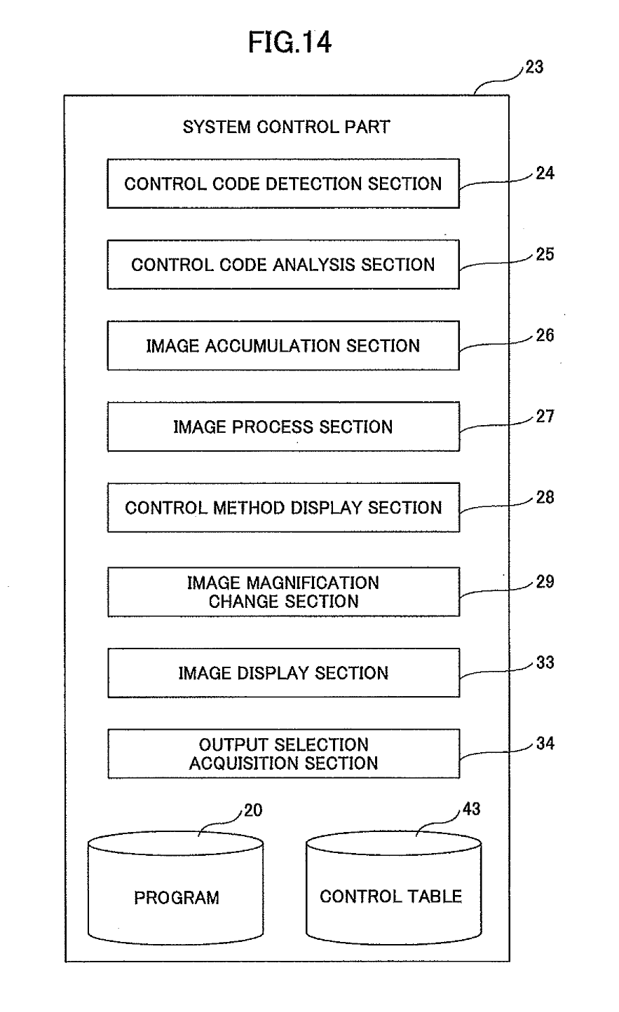

FIG. 14 is a block diagram of the system control part 23 according to the third embodiment of the present invention. In FIG. 14, parts that are the same as the parts shown in FIG. 7 are given the same reference numerals, and descriptions thereof will be omitted. The system control part 23 shown in FIG. 14 includes an output selection acquisition section 34 which acquires an outputting means selected by a user by operating the operation/display part 15. The output selection acquisition section 34 acquires the outputting means, which is selected by an operation of the operation/display part 15 by a user from among the control methods displayed on the operation/display section 15. The display screen of the control method may be any one of the display screen shown in FIG. 5 or 8, which displays the control method page by page, the display screen shown in FIG. 10, which simultaneously displays a plurality of control methods, and the display screen shown in FIG. 12, which simultaneously displays a plurality of control methods and a plurality of reduced images.

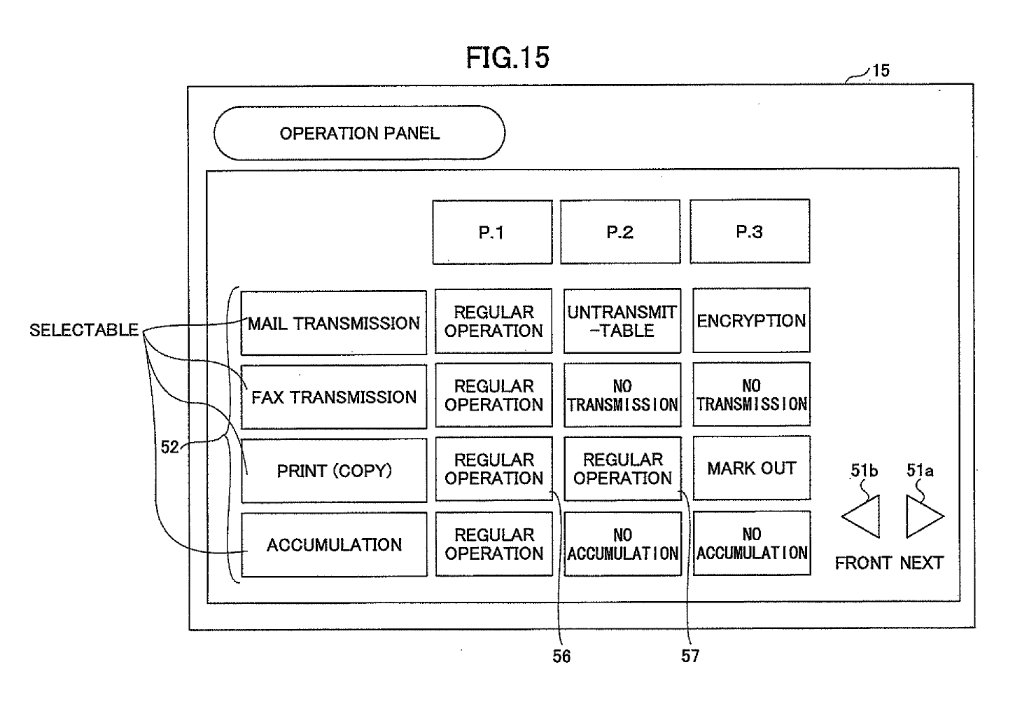

FIG. 15 shows an example of the display screen of a plurality of control methods, which allows selection of an outputting means. A user can select a desired outputting means from the display screen of FIG. 15. It should be noted that selection is not limited to alternative selection (select one), and a plurality of outputting means may be selected. For example, in the case of FIG. 15, if a user selects “FAX transmission”, only P.1 is transmitted by facsimile because P.1 is designated as “regular operation” (permission), P.2 is designated as “no transmission” (not permitted) and P.3 is designated as “no transmission” (not permitted). Because the output selection acquisition section 34 acquires a result of selection of a user through the operation/display part 15, the system control part 23 controls the selected outputting means (for example, the plotter apparatus 13, the communication control part 19, the electronic mail control part 22, or the image storage part 17a).

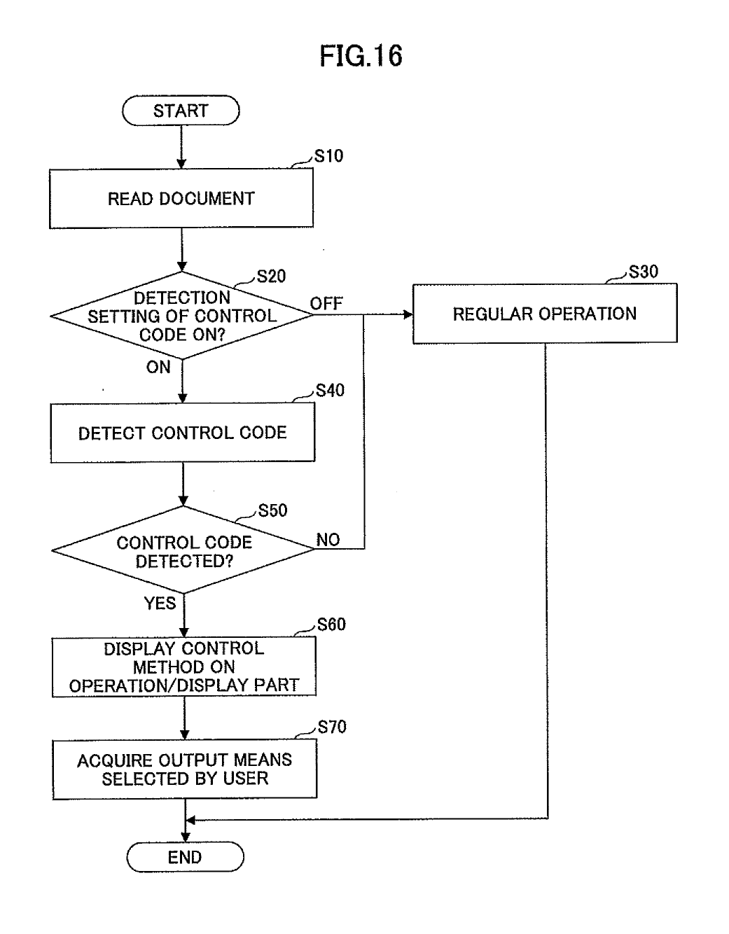

FIG. 16 is a flowchart of a procedure of the system control part 23 to display the control methods and acquire a desired outputting means selected by a user. In FIG. 16, steps that are the same as the steps shown in FIG. 6 are given the same step numbers, and descriptions thereof will be omitted. The process shown in FIG. 16 is the same as that of the first and second embodiments until the control method is displayed on the operation/display part 15 (step S60). Because the display screen shown in FIG. 15 is displayed by the process to step S60, the output selection acquisition section 34 acquires an outputting means selected by the user (step S70). Thereby, image processing apparatus 100 can output the image data only from the selected outputting means. Therefore, the user can select the outputting means upon checking the displayed control methods, which improves an operability of the apparatus by effectively using the display of the control methods.

<Selection of Outputting Means for Each Page>

If an outputting means is selected common to all pages, there may be an undesirable case where there are pages which are output and pages which are not output. If, for example, “print” is selected as an outputting means and if an output of a part of the pages is not permitted, the part of the pages is marked out by a toner image, which results in waste of toner. Accordingly, it is convenient if the user can select whether to output or not output for each page. Although the control method display section 28 displays the control method in the same manner as that shown in FIG. 15, a user can select an outputting means on an individual page basis. For example, if a user desires to select printing, the user may select “print” and the “regular operation” 56 corresponding to P.1 and “print” and “regular operation” 57 corresponding to P.2 from among P.1 to P.3 because there is no need to output the pages which will be output by being marked out. By making the selection as mentioned above, only the pages of which output is permitted are printed, which eliminates a waste of a toner. It should be noted that the outputting means may be changed page by page. Accordingly, for example, in a case where a mail transmission is not permitted but print is permitted for a predetermined page, an appropriate outputting means can be selected for each page.

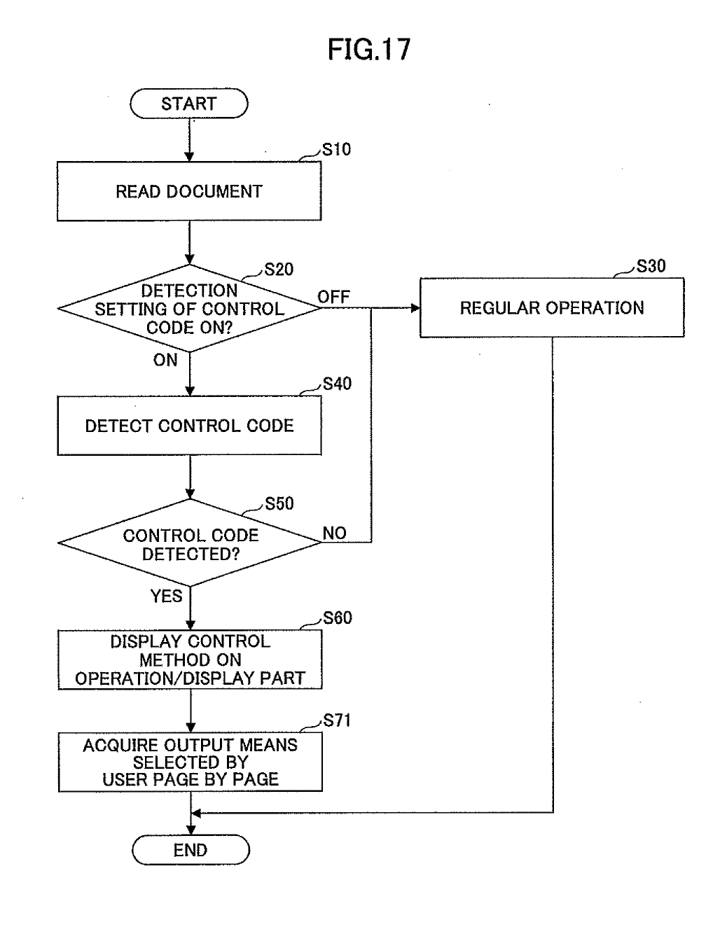

FIG. 17 is a flowchart of a procedure of the system control part 23 to display a control method and acquire an outputting means selected for each page. In FIG. 17, steps that are the same as the steps shown in FIG. 16 are given the same step numbers, and descriptions thereof will be omitted. The process shown in FIG. 17 differs from the process shown in FIG. 16 in that the process shown in FIG. 17 includes a step S71 in which the output selection acquisition section 34 selects an outputting means on an individual page basis. Accordingly the image processing apparatus 100 can acquire an outputting means selected for each page and output the image data, which can improve an operability of the apparatus by effectively using the display of the control method.

<Transmission Setup for Each Address>

There may be an outputting means in which addresses are set up, such as electronic mail or facsimile. Although the control code 42 defines a control method irrespective of an address, it may be convenient that further selection can be made whether to “transmit” or “not transmit” for each address if an output of the page concerned is permitted.

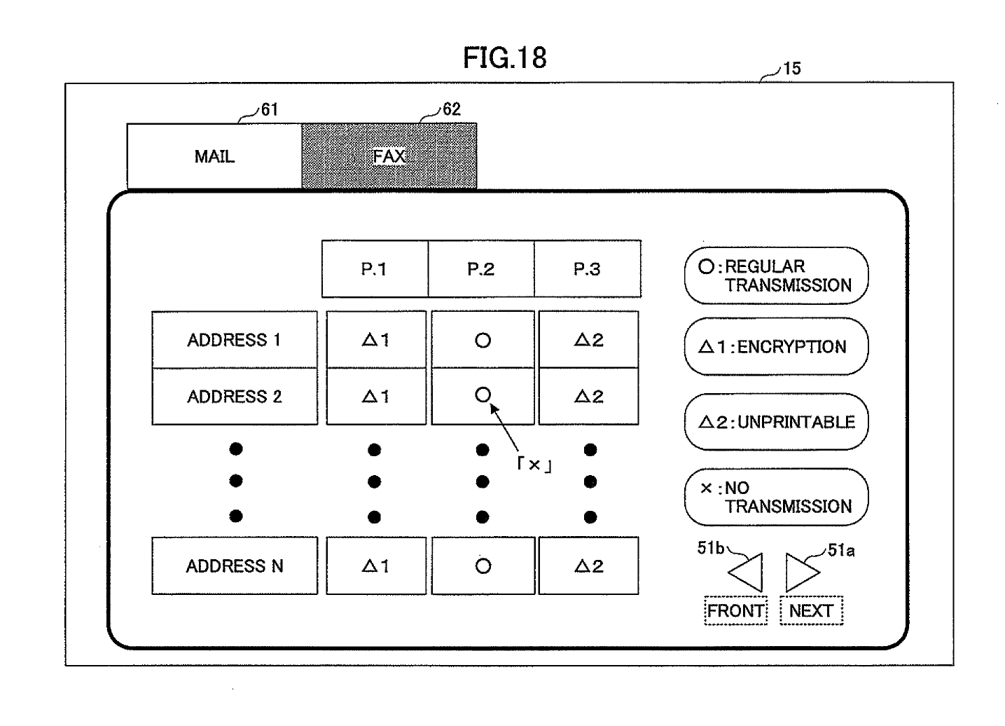

FIG. 18 shows an example of a display screen of control methods displayed on the operation/display part 15 for each address. The application of electronic mail and the application of facsimile can be alternately displayed by switching by operating a mail tag 61 and a mail tag 62. In the initial state, the same control method is displayed for each address 1 to N for each page. It should be noted that the addresses are user's names, and a mail address and a facsimile number of each destination are stored in the address book 18.

In FIG. 18, the control method of each page is set as follows.

P.1: transmit after encryption

P.2: designate address from address book 18 only

P.3: transmit by setting unable to print

For example, if there is no need to transmit P.2 to the address 2, a user can prohibit the transmission by changing to “no transmission” (X). Because the output selection acquisition section 34 acquires a result of selection for each address made by a user, the system control part 23 controls an outputting means (for example, the communication control part 19, or the electronic mail control part 22) for each address. That is, if the outputting means is a mail transmission system and if the outputting means is transmitted for each address, a control is made whether to encrypt the information to be transmitted. If the outputting means is a facsimile transmission system, a control is made whether to transmit for each address.

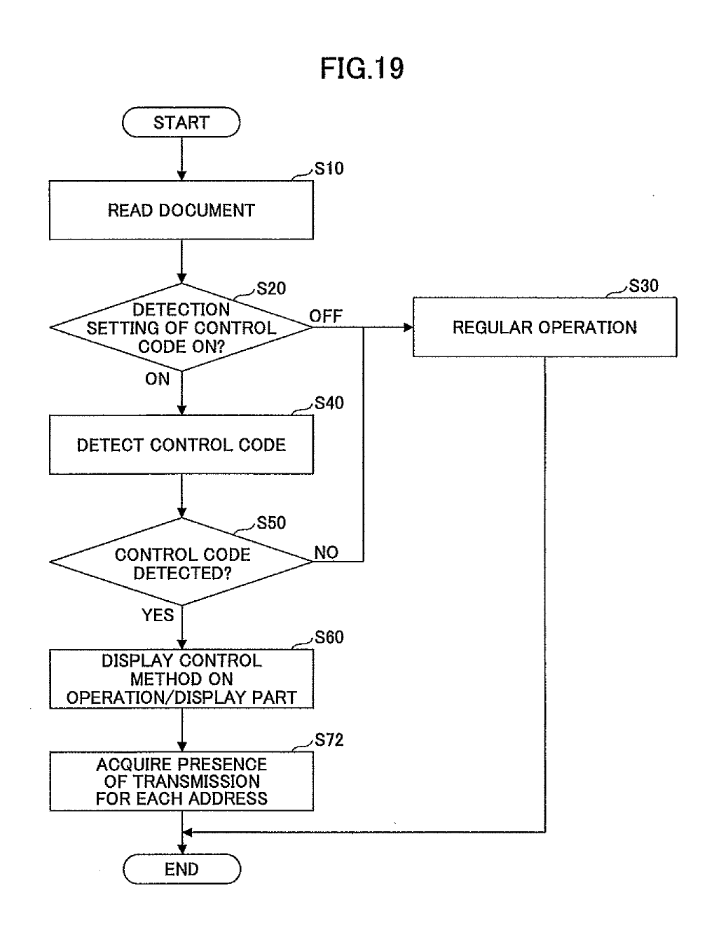

FIG. 19 is a flowchart of a procedure of the system control part 23 to display a control method and acquire information regarding whether to transmit or not, which is selected by a user for each address. In FIG. 19, steps that are the same as the steps shown in FIG. 17 are given the same step numbers, and descriptions thereof will be omitted. The process of FIG. 19 differs from the process of FIG. 17 in that the process of FIG. 19 includes a step S72 in which the output selection acquisition section 34 acquires information regarding whether to transmit for each address. Because a user can select whether to transmit or not transmit for each page upon checking the control method, a convenience can be improved. It should be noted that if a user is given authority such as a management person, a convenience can be further improved by permitting such a user to change “no transmission” to “regular transmission”.

### Fourth Embodiment

Even if an output is made in consideration of leak of information according to the above-mentioned first to third embodiments, it is believed that a leak source can be easily found even later, by recording a result of an actual output. Thus, in the fourth embodiment, the image processing apparatus 100 is provided with a function to record an output result.

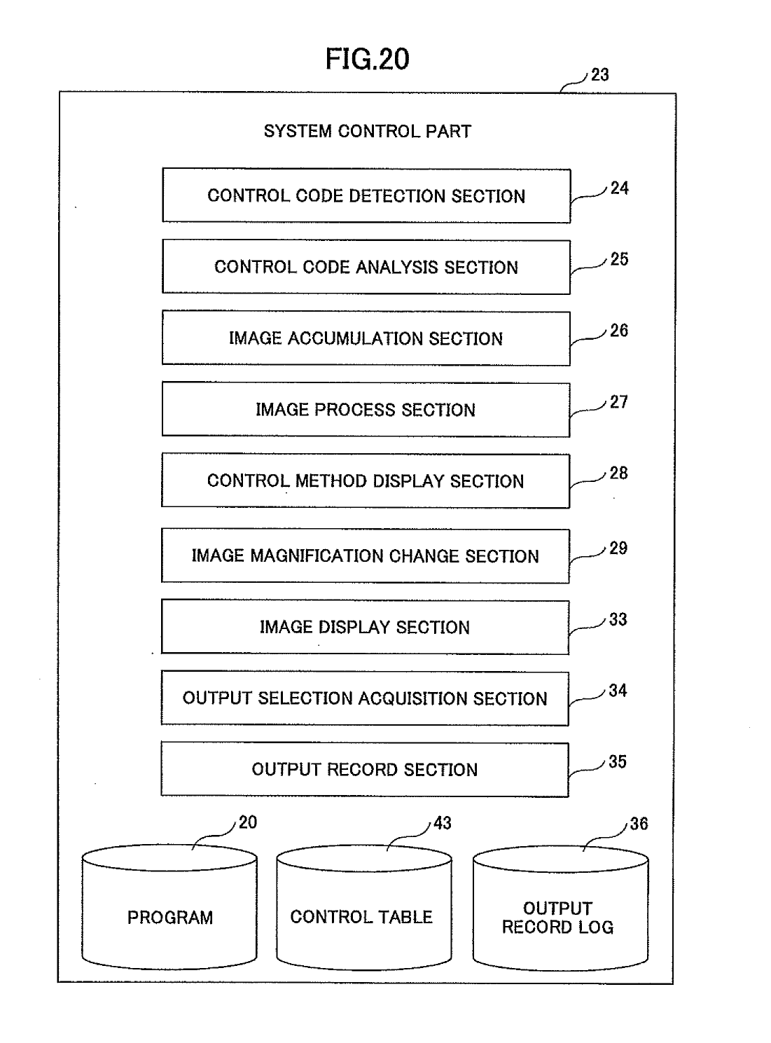

FIG. 20 is a block diagram of the system control part 23 according to the fourth embodiment of the present invention. In FIG. 20, parts that are the same as the parts shown in FIG. 14 are given the same reference numerals, and descriptions thereof will be omitted. The system control part 23 of FIG. 20 includes an output record section 35 that records a result of output. The output record section 35 stores in the memory (an output record log storage part) an output record log 36 in which information regarding the outputting means and date and time, when image data is output, are recorded.

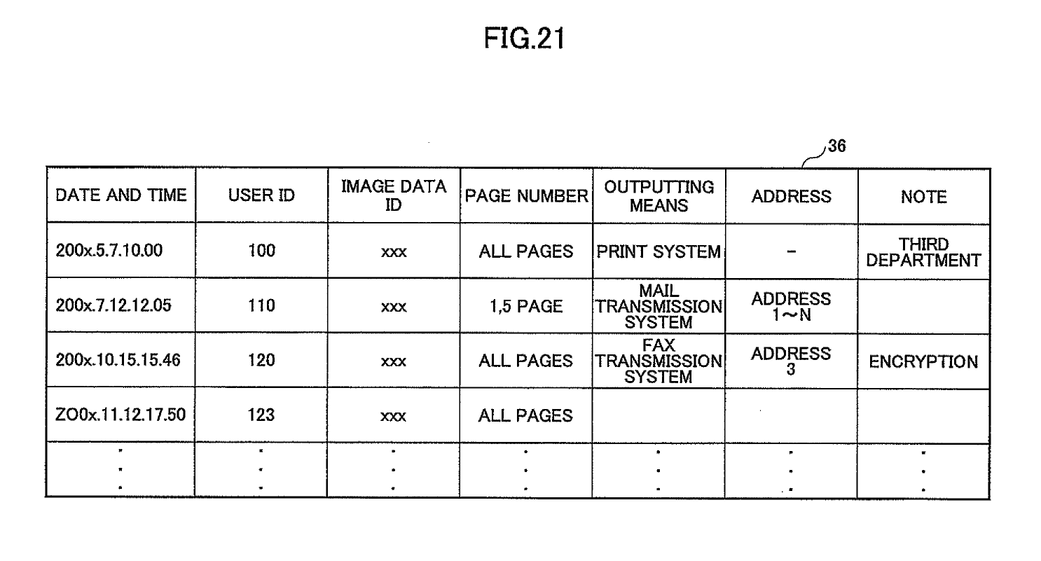

FIG. 21 shows an example of the output record log 36. The output record log 36 of FIG. 21 includes items of the output, that are “time”, “user ID”, “image data ID”, “page number”, “outputting means”, “address”, and “note” so that the output record section 35 can record each item when an output is made. Accordingly, a record is made as to when and how and who outputs which page of which image data. It should be noted that the image data ID is an identifier for identifying image data, and is given automatically when the image data is stored in the image storage part 17a.

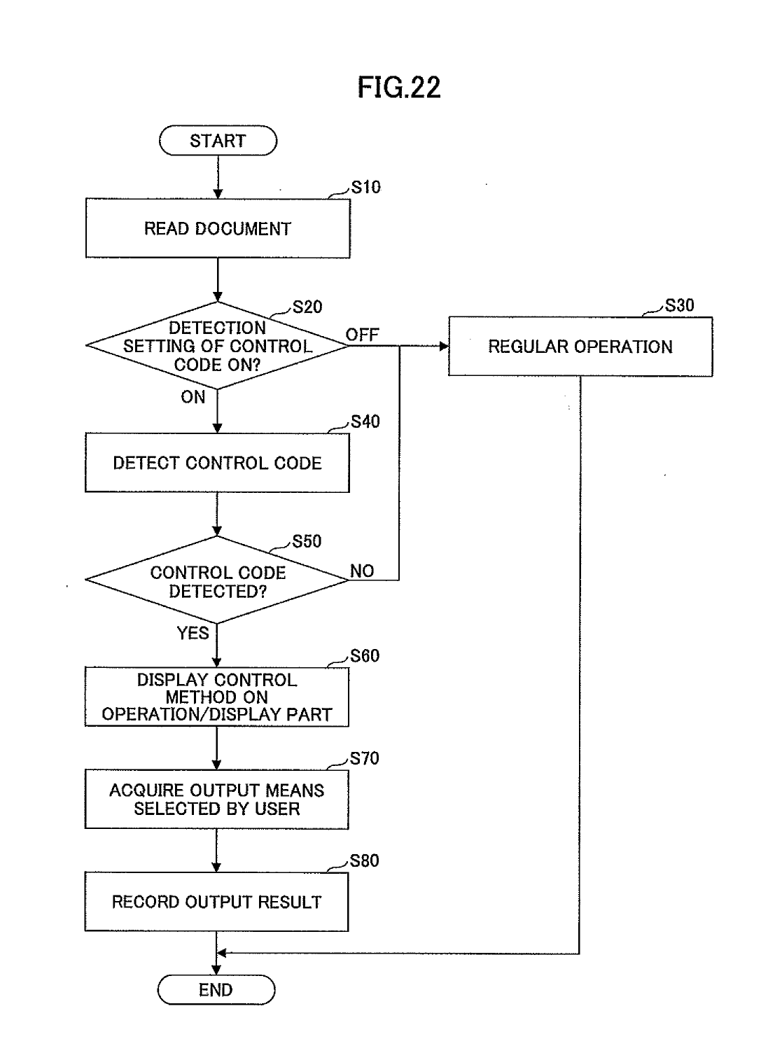

FIG. 22 is a flowchart of a procedure of the system control part 23 to display a control method and indicate a procedure of recording a result of an output. In FIG. 22, steps that are the same as the steps shown in FIG. 16 are given the same step numbers, and description thereof will be omitted. The process shown in FIG. 22 differs from the process shown in FIG. 16 in that the process shown in FIG. 22 includes a step S80 in which the output record section 35 records a result of an output. According to the present embodiment, because an outputting operation performed by a user is recorded for each page, a result of an output of a document, especially, a confidential document, can be checked by the output record log 36. Thus, if leak of information occurs, tracing of a leak path can be more easily performed, which can improve convenience.

As explained above, in the image processing apparatus according to the present embodiment, it can be easily checked as to which outputting means and which outputting method are permitted, by displaying a control method corresponding to a control code embedded in a document. Additionally, an output can be made by merely selecting the outputting means for which output is permitted, and, further, a result of the output can be recorded, which can improve an operability of the apparatus.

According to the above-mentioned embodiment, there is provided an image processing method performed by the image processing apparatus 100 that detects a control code provided to a document in order to prevent image data, which is created by reading the document, from being leaked in accordance with the detected control code. The image processing method includes the steps of storing the control code by relating to a control method to prevent leaking, and displaying the control method, which is retrieved from the control table storage part, on a display part based on the control code.

The above-mentioned method can be described in a computer readable program and may be stored in a computer readable recording medium such as a CD-ROM. The image processing apparatus 100 reads the program from the recording medium attached to the removable memory attachment part 31, and the system control part 23 executes the program to perform the image processing method.

The present invention is not limited to the specifically disclosed embodiments, and variations and modifications may be made without departing from the scope of the present invention.

The present application is based on Japanese priority application No. 2007-199911 filed Jul. 31, 2007, the entire contents of which are hereby incorporated herein by reference.

What is claimed is:

1. An image processing apparatus that detects a control code provided to a document in order to prevent image data, which is created by reading the document, from being leaked in accordance with the detected control code, the image processing apparatus comprising:
a control table storage part that stores said control code by relating to a control method to prevent leaking; and
a control method display section that displays said control method, which is retrieved from said control table storage part, on a display part based on said control code.

2. The image processing apparatus as claimed in claim 1, further comprising:
an image storage part that stores said image data; and
an image magnification change section that applies a magnification change process to said image data stored in said image storage part,
wherein said control method display section displays, in addition to said control method, an image of said image data, which has been processed by said image magnification change section, on said display part.

3. The image processing apparatus as claimed in claim 1, further comprising a control code storage part that stores said control code detected for each page of said document, wherein said control method display section displays on said display part a plurality of said control methods of a plurality of number of pages, the plurality of said control methods being retrieved from said control table storage part based on a plurality of said control codes provided to said plurality of number of pages.

4. The image processing apparatus as claimed in claim 3, wherein said control method display section displays said control methods of all pages of said document on said display part.

5. The image processing apparatus as claimed in claim 3, further comprising:
an image storage part that stores a plurality of sets of said image data;
an image magnification change section that applies a magnification change process to said plurality of sets of image data stored in said image storage part,
wherein said control method display section simultaneously displays on said display part the plurality of said control method of the plurality of number of pages and a plurality of images of the plurality of sets of image data, which have been subjected to the magnification change process.

6. The image processing apparatus as claimed in claim 1, further comprising:
a plurality of outputting units that outputs said image data;
an operation part operated by a user; and
an output selection acquisition section that acquires selection information of said outputting units selected through said operation part,
wherein said image data is output by one of said outputting units designated by said selection information.

7. The image processing apparatus as claimed in claim 6, wherein said output selection acquisition section acquires said selection information for each page of said document.

8. The image processing apparatus as claimed in claim 6, further comprising an address information storage part that stores address information regarding a plurality of addresses to which said image data is transmitted, wherein, when one of said outputting units, which requires said address information to output said image data, is selected, said output selection acquisition section acquires transmission information regarding whether to transmit the image data for each address in said address information.

9. The image processing apparatus as claimed in claim 1, further comprising an output record section that stores an output record log in an output record log storage part, when said image data is output by one of said outputting units, the output record log recording information regarding the one of said outputting units which outputs said image data and date and time of said image data being output.

10. An image processing method performed by an image processing apparatus that detects a control code provided to a document in order to prevent image data, which is created by reading the document, from being leaked in accordance with the detected control code, the image processing method comprising:
storing said control code by relating to a control method to prevent leaking; and
displaying said control method, which is retrieved from said control table storage part, on a display part based on said control code.

11. A computer readable program for causing an image processing apparatus to perform functions of:
detecting a control code provided to a document in order to prevent image data, which is created by reading the document, from being leaked in accordance with the detected control code;
storing said control code by relating to a control method to prevent leaking; and
displaying said control method, which is retrieved from said control table storage part, on a display part based on said control code.
